(19) United States
(12) Patent Application Publication
(10) Pub. No.: US 2015/0315489 A1
(43) Pub. Date: Nov. 5, 2015

(54) METHODS AND SYSTEMS FOR REDUCING FUEL OIL VISCOSITY AND FLUX REQUIREMENTS

(71) Applicants: Patrick Loring Hanks, Bridgewater, NJ (US); Michel DAAGE, Hellertown, PA (US); Thomas Francis DEGNAN, JR., Philadelphia, PA (US)

(72) Inventors: Patrick Loring Hanks, Bridgewater, NJ (US); Michel DAAGE, Hellertown, PA (US); Thomas Francis DEGNAN, JR., Philadelphia, PA (US)

(73) Assignee: ExxonMobil Research and Engineering Company, Annandale, NJ (US)

(21) Appl. No.: 14/691,871

(22) Filed: Apr. 21, 2015

Related U.S. Application Data
(60) Provisional application No. 61/986,956, filed on May 1, 2014.

(51) Int. Cl. C10G 55/02; C10G 57/00; C10G 57/02; B01J 19/24; C10G 69/02

(52) U.S. Cl. CPC C10G 55/02; B01J 19/24; C10G 69/02; C10G 57/02; C10G 57/005; B01J 2219/24

(57) ABSTRACT

Systems and methods are provided for converting resids to oil streams useful as fuel oils by utilizing hydrodynamic cavitation. The cavitated fuel oils are more suitable for subsequent conversion to lighter products (e.g., through fluid catalytic cracking) or they can be blended to produce heating oils or bunker fuels.

### CROSS-REFERENCE TO RELATED APPLICATION

The present application claims priority to U.S. Patent Application Ser. No. 61/986,956, filed on May 1, 2014.

### FIELD

The present invention relates to a method and system for treating resids and specifically for producing fuel oils of lower viscosity. More specifically, the present invention relates to methods and systems of reducing fuel oil viscosity utilizing hydrodynamic cavitation.

### BACKGROUND

Many refineries use visbreaking of resids to reduce viscosity where the lower viscosity products are useful for use as fuel oils. In some cases, visbreaking may impose unacceptable capital or operational expenses. Even in other cases where the costs of visbreaking are economically justifiable, lower cost options are desired.

Accordingly, it would be desirable to provide a lower cost option to visbreaking for reducing the viscosity of resids used in fuel oils.

### SUMMARY

The present invention addresses these and other problems by providing systems and methods for converting resids to oil streams useful in fuel oils by utilizing hydrodynamic cavitation.

In one aspect, a method is provided for treating a hydrocarbon stream for use in a fuel oil. The method includes subjecting a resid feed to hydrodynamic cavitation to crack at least a portion of the hydrocarbons present in the resid feed, and thereby produce a cavitated resid; and removing a light fraction from the cavitated resid to produce an oil stream having a flash point greater than 60° C.

In another aspect, a system is provided for treating a hydrocarbon stream for use in a fuel oil. The system includes a resid feed, a hydrodynamic cavitation unit receiving the resid feed and subjecting the resid feed to hydrodynamic cavitation to crack at least a portion of the hydrocarbons present in the resid feed and thereby produce a cavitated resid; and a vapor removal device receiving the cavitated resid and adapted to remove a light fraction from the cavitated resid to produce an oil stream having a flash point greater than 60° C.

### BRIEF DESCRIPTION OF THE DRAWINGS

FIG. 1 is a cross section view of an exemplary hydrodynamic cavitation unit, which may be employed in one or more embodiments of the present invention.

FIG. 2 is a flow diagram of a system for reducing viscosity of resid for use in a fuel.

FIG. 3 is a flow diagram of a system for reducing viscosity of resid for use in a fuel.

FIG. 4 is a flow diagram of a system for reducing viscosity of resid for use in a fuel.

### DETAILED DESCRIPTION

Methods and systems are provided for cost-effective viscosity reduction of heavy hydrocarbon oils, such as a residual oil feed stream, e.g., a vacuum or atmospheric resid, for use in fuel oils. Applicable feeds for use with such methods and systems and methods include bottoms products of atmospheric and vacuum pipestills. The methods and systems disclosed herein are particularly advantageous for hydrocarbon-containing streams having a T95 (temperature at 95 wt % of the material boils off at atmospheric pressure) of 650° F. or greater, or more preferably 800° F. or greater, or even more preferably 1100° F. or greater.

Advantageously and surprisingly, the methods and systems disclosed herein may achieve greater liquid viscosity reduction than with conventional visbreaking. Furthermore, such systems will generally occupy a smaller footprint in the refinery. The lower operating temperatures may also reduce emissions of CO₂ and other gases. In addition, cavitation was found to produce a different yield slate than visbreaking. Specifically, smaller amounts of naphtha and distillate were produced relative to visbreaking, so recovery of these fractions may be unnecessary.

Generally, methods are disclosed herein for reducing the viscosity of a heavy hydrocarbon feed for use in a fuel oil. The method may include subjecting a resid feed to hydrodynamic cavitation and thereby cracking at least a portion of the hydrocarbons present in the resid feed to produce a cavitated resid having a viscosity that is at least 50% less than the viscosity of the resid feed; and preparing a fuel oil comprising the cavitated resid. The fuel oil may have a viscosity less than or equal to about 380 cSt at 50° C. as measured by ASTM D445. The fuel oil may also have a specific gravity of between about 0.96 and about 1.01 and can be measured by ASTM D4052. The fuel oil may also have a maximum sulfur level of 3.5 wt % or less, or 1.5 wt % or less as measured by ASTM D2622.

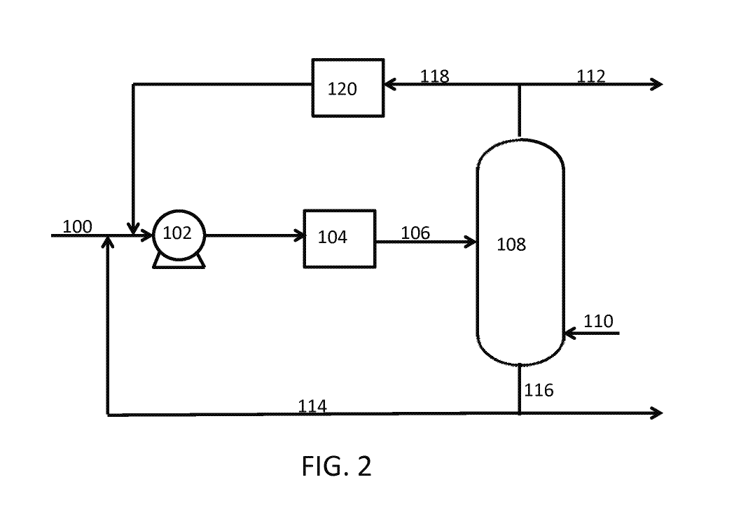

An embodiment for reducing viscosity of a heavy hydrocarbon feed, which may be any of the feeds disclosed herein, is illustrated in FIG. 2. Resid feed 100 is fed to hydrodynamic cavitation unit 104 under conditions suitable to crack at least a portion of the hydrocarbon molecules in the resid feed 100 and thereby reduce the viscosity of the resulting cavitated resid 106. Cavitation may reduce the viscosity of the resid feed by at least 50%, as measured at 50° C.

The cavitated resid 106, now having a reduced viscosity, is fed to a separator 108, which may be any type of vapor-liquid separation device, where it is mixed with a stripping gas, such as steam, nitrogen or methane, 110. A portion of the product stream 116 may be used for flux for resid feed 100 by stream 114 which feeds into the resid feed 100 upstream of the pump 102 and hydrodynamic cavitation unit 104. The product obtained from product stream 116 may be used in a fuel oil.

In addition, a portion 118 of the light ends product 112 may be condensed by condenser 120 and fed upstream of the hydrodynamic cavitation unit 104. The stream 118 therefore may be used to modify vapor pressure and the amount of dissolved gas present in the hydrodynamic cavitation unit 104. This allows for a broader range of control for the amount and severity of cavitation events occurring in the hydrodynamic cavitation unit 104.

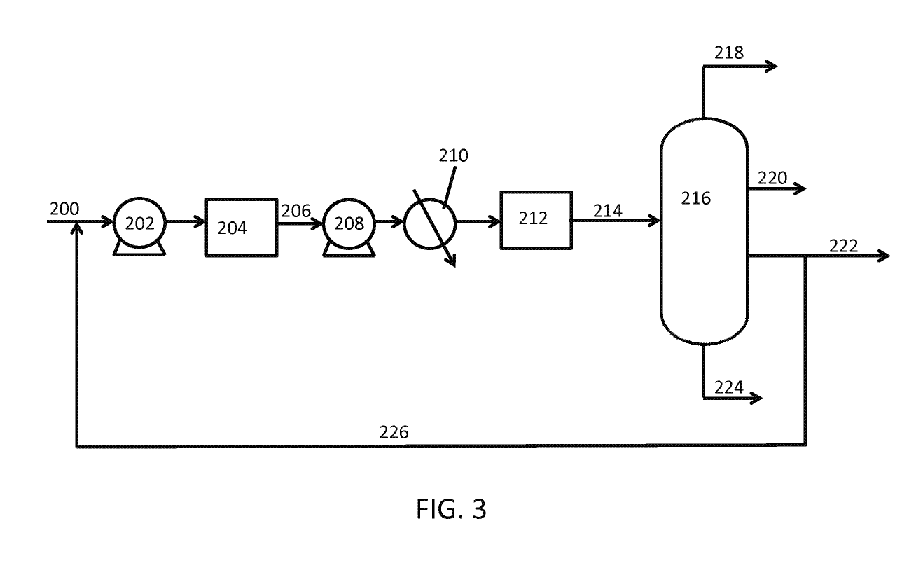

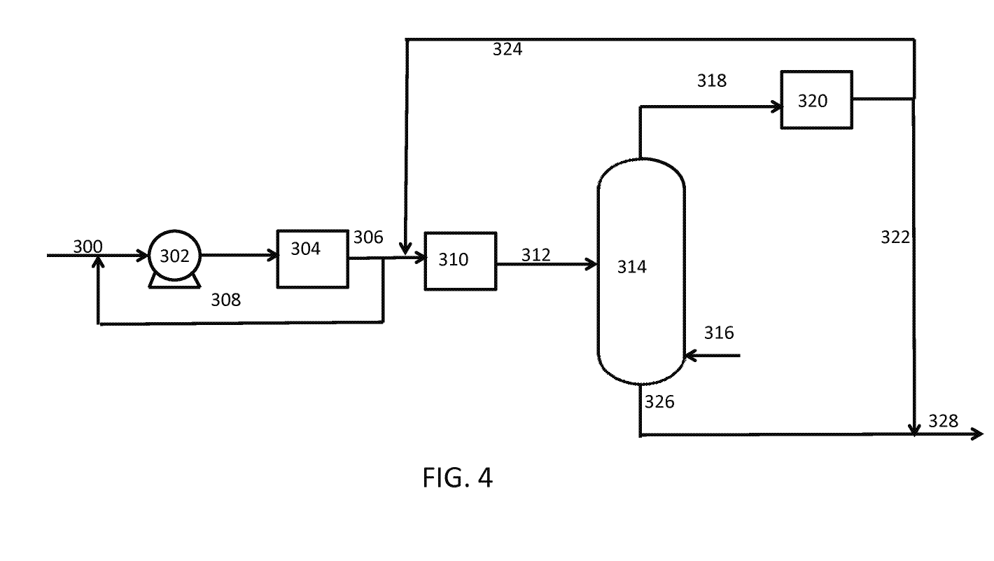

Other variations are illustrated in FIGS. 3 and 4. As illustrated in FIG. 3, resid feed 200 is fed to a first hydrodynamic cavitation unit 204 by pump 202 to produce a first cavitated resid stream 206. The first cavitated resid stream 206 may have a viscosity that is lower than that of resid feed 200. The first cavitated resid stream 206 may then be fed to heat exchanger 210 and second hydrodynamic cavitation unit 212 to produce a second cavitated resid stream 214, which has a lower viscosity than that of first cavitated resid stream 206. The second cavitated resid stream 214 is then fed to separator 216, which fractionates the cavitated resid into different product fractions, such as light ends 218, and gas oils 220, 222, and 224, which may be used in fuel oils. In the illustrated embodiment, an intermediate gas oil fraction 222 is fed back via stream 226 to be used as a diluent of resid feed 200 upstream of the first hydrodynamic cavitation unit 204.

As illustrated in FIG. 4, resid feed 300 is fed to a first hydrodynamic cavitation unit 304 by pump 302 to produce a first cavitated resid stream 306. A portion of the first cavitated resid stream 306 may be fed back via flux stream 308 and used as a diluent for resid feed 300. The first cavitated resid stream 306 is then fed to second hydrodynamic cavitation unit 310 to produce a second cavitated resid stream 312, which has a lower viscosity than the first cavitated resid stream 306. The second cavitated resid stream 312 is then fed to separator 314, which may be any type of vapor-liquid separator, where it is mixed with steam 316. The second cavitated resid stream 312 is separated into a light hydrocarbon stream 318 and a heavy hydrocarbon stream 326. The light hydrocarbon stream 318 may then be fed to a hydrotreater 320 to form a hydrotreated light stream 322 which is mixed with the heavy hydrocarbon stream 326 to form a product stream 328, which may be used in a fuel oil.

In addition, a portion of the hydrotreated light stream 322 may be fed back via stream 324 upstream of the second hydrodynamic cavitation unit 310. The stream 324 therefore may be used to modify vapor pressure and the amount of dissolved gas present in the second hydrodynamic cavitation unit 310. This allows for a broader range of control for the amount and severity of cavitation events occurring in the second hydrodynamic cavitation unit 310.

It should be appreciated that the embodiments illustrated in FIGS. 2-4 are not intended to be exclusive of each other and the operations and equipment illustrated in each FIG. can be employed in any embodiment. As such, the referenced drawings views should be understood to be merely illustrative of some of the variations possible of the present invention. The specifics of the hydrodynamic cavitation units are described in greater detail subsequently, but it should be noted that the cavitation devices can be a multi-stage cavitation device or a single stage. In addition, there can be multiple devices of any number of stages in series or parallel.

Between cavitation devices in series there may be optional pumps to increase fluid pressure to any desired pressure. Heat exchange equipment may also be employed to heat or cool the liquid to modify vapor pressure and/or the viscosity of the fluid. Vapor-liquid separation devices to remove light ends to modify vapor pressure and the amount of dissolved gas in the liquid (e.g., to control cavitation events or intensity). In addition, some amount of material can be recycled to any of the stages to control cavitation or to be used as a diluent. Optionally, a fraction, such as naphtha or light ends, may be removed and bypass the rest of the process or any particular unit.

### Hydrodynamic Cavitation Unit

The term “hydrodynamic cavitation”, as used herein refers to a process whereby fluid undergoes convective acceleration, followed by pressure drop and bubble formation, and then convective deceleration and bubble implosion. The implosion occurs faster than mass in the vapor bubble can transfer to the surrounding liquid, resulting in a near adiabatic collapse. This generates extremely high localized energy densities (temperature, pressure) capable of dealkylation of side chains from large hydrocarbon molecules, creating free radicals and other sonochemical reactions.

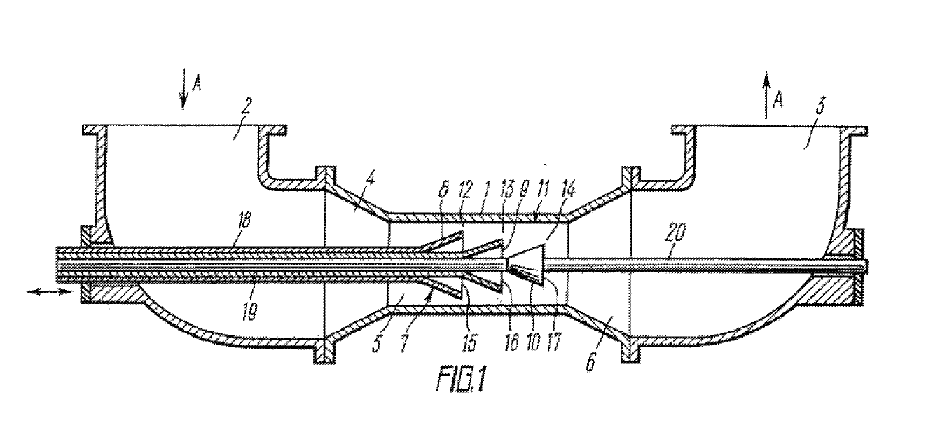

The term “hydrodynamic cavitation unit” refers to one or more processing units that receive a fluid and subject the fluid to hydrodynamic cavitation. In any embodiment, the hydrodynamic cavitation unit may receive a continuous flow of the fluid and subject the flow to continuous cavitation within a cavitation region of the unit. An exemplary hydrodynamic cavitation unit is illustrated in FIG. 1. Referring to FIG. 1, there is a diagrammatically shown view of a device consisting of a housing I having inlet opening 2 and outlet opening 3, and internally accommodating a contractor 4, a flow channel 5 and a diffuser 6 which are arranged in succession on the side of the opening 2 and are connected with one another. A cavitation region defined at least in part by channel 5 accommodates a baffle body 7 comprising three elements in the form of hollow truncated cones 8, 9, 10 arranged in succession in the direction of the flow and their smaller bases are oriented toward the contractor 4. The baffle body 7 and a wall 11 of the flow channel 5 form sections 12, 13, 14 of the local contraction of the flow arranged in succession in the direction of the flow and shaving the cross-section of an annular profile. The cone 8, being the first in the direction of the flow, has the diameter of a larger base 15 which exceeds the diameter of a larger base 16 of the subsequent cone 9. The diameter of the larger base 16 of the cone 9 exceeds the diameter of a larger base 17 of the subsequent cone 10. The taper angle of the cones 8, 9, 10 decreases from each preceding cone to each subsequent cone.

The cones may be made specifically with equal taper angles in an alternative embodiment of the device. The cones 8, 9, 10 are secured respectively on rods 18, 19, 20 coaxially installed in the flow channel 5. The rods 18, 19 are made hollow and are arranged coaxially with each other, and the rod 20 is accommodated in the space of the rod 19 along the axis. The rods 19 and 20 are connected with individual mechanisms (not shown in FIG. 1) for axial movement relative to each other and to the rod 18. In an alternative embodiment of the device, the rod 18 may also be provided with a mechanism for movement along the axis of the flow channel 5. Axial movement of the cones 8, 9, 10 makes it possible to change the geometry of the baffle body 7 and hence to change the profile of the cross-section of the sections 12, 13, 14 and the distance between them throughout the length of the flow channel 5 which in turn makes it possible to regulate the degree of cavitation of the hydrodynamic cavitation fields downstream of each of the cones 8, 9, 10 and the multiplicity of treating the components. For adjusting the cavitation fields, the subsequent cones 9, 10 may be advantageously partly arranged in the space of the preceding cones 8, 9, however, the minimum distance between their smaller bases should be at least equal to 0.3 of the larger diameter of the preceding cones 8, 9, respectively. If required, one of the subsequent cones 9, 10 may be completely arranged in the space of the preceding cone on condition of maintaining two working elements in the baffle body 7. The flow of the fluid under treatment is show by the direction of arrow A.

Hydrodynamic cavitation units of other designs are known and may be employed in the context of the inventive systems and processes disclosed herein. For example, hydrodynamic cavitation units having other geometric profiles are illustrated and described in U.S. Pat. No. 5,492,654, which is incorporated by reference herein in its entirety. Other designs of hydrodynamic cavitation units are described in the published literature, including but not limited to U.S. Pat. Nos. 5,937,906; 5,969,207; 6,502,979; 7,086,777; and 7,357,566, all of which are incorporated by reference herein in their entirety.

In an exemplary embodiment, conversion of hydrocarbon fluid is achieved by establishing a hydrodynamic flow of the hydrodynamic fluid through a flow-through passage having a portion that ensures the local constriction for the hydrodynamic flow, and by establishing a hydrodynamic cavitation field (e.g., within a cavitation region of the cavitation unit) of collapsing vapor bubbles in the hydrodynamic field that facilitates the conversion of at least a part of the hydrocarbon components of the hydrocarbon fluid.

For example, a hydrocarbon fluid may be fed to a flow-through passage at a first velocity, and may be accelerated through a continuous flow-through passage (such as due to constriction or taper of the passage) to a second velocity that may be 3 to 50 times faster than the first velocity. As a result, in this location the static pressure in the flow decreases, for example from 1-20 kPa. This induces the origin of cavitation in the flow to have the appearance of vapor-filled cavities and bubbles. In the flow-through passage, the pressure of the vapor hydrocarbons inside the cavitation bubbles is 1-20 kPa. When the cavitation bubbles are carried away in the flow beyond the boundary of the narrowed flow-through passage, the pressure in the fluid increases.

This increase in the static pressure drives the near instantaneous adiabatic collapsing of the cavitation bubbles. For example, the bubble collapse time duration may be on the magnitude of 10⁻⁶ to 10⁻⁸ second. The precise duration of the collapse is dependent upon the size of the bubbles and the static pressure of the flow. The flow velocities reached during the collapse of the vacuum may be 100-1000 times faster than the first velocity or 6-100 times faster than the second velocity. In this final stage of bubble collapse, the elevated temperatures in the bubbles are realized with a velocity of 10¹⁰-10¹² K/sec. The vaporous/gaseous mixture of hydrocarbons found inside the bubbles may reach temperatures in the range of 1500-15,000K at a pressure of 100-1500 MPa. Under these physical conditions inside of the cavitation bubbles, thermal disintegration of hydrocarbon molecules occurs, such that the pressure and the temperature in the bubbles surpasses the magnitude of the analogous parameters of other cracking processes. In addition to the high temperatures formed in the vapor bubble, a thin liquid film surrounding the bubbles is subjected to high temperatures where additional chemistry (i.e., thermal cracking of hydrocarbons and dealkylation of side chains) occurs. The rapid velocities achieved during the implosion generate a shockwave that can: mechanically disrupt agglomerates (such as asphaltene agglomerates or agglomerated particulates), create emulsions with small mean droplet diameters, and reduce mean particulate size in a slurry.

### SPECIFIC EMBODIMENTS

To further illustrate aspects of the present invention, the following specific embodiments are provided:

Paragraph A—A method of treating a hydrocarbon stream for use in a fuel oil comprising: subjecting a resid feed to hydrodynamic cavitation to crack at least a portion of the hydrocarbons present in the resid feed and thereby produce a cavitated resid; and removing a light fraction from the cavitated resid to produce an oil stream having a flash point greater than 60° C. as measured by ASTM D6540.

Paragraph B—The method of Paragraph A, further comprising preparing a fuel oil comprising the oil stream.

Paragraph C—The method of Paragraph A or B, wherein the resid feed has a T95 of 800° F. or greater.

Paragraph D—The method of any of Paragraphs A-C, wherein the resid feed comprises a 1050+° F. boiling point fraction, and wherein 1 to 35 wt % of the 1050+° F. boiling point fraction is converted to lower molecular weight hydrocarbons when subjected to hydrodynamic cavitation.

Paragraph E—The method of any of Paragraphs A-D, wherein the cavitated resid stream has a viscosity, less than 90%, less than 80%, less than 70%, less than 60%, less than 50%, less than 40%, less than 30%, less than 20%, or less than 10% of the viscosity of the resid feed as measured at 40° C. or 100° C. in accordance with ASTM D445.

Paragraph F—The method of any of Paragraphs A-E, wherein the oil stream has an API gravity greater than the resid feed.

Paragraph G—The method of any of Paragraphs A-F, wherein the oil stream has a solubility number that is at least 10 points greater than the insolubility number for the oil stream, preferably 15 points greater, and more preferably 20 points greater.

Paragraph H—The method of any of Paragraphs A-G, wherein the light fraction is scrubbed with an amine solution.

Paragraph I—The method of Paragraph H, wherein the light fraction is used as a fuel gas after being scrubbed with an amine solution.

Paragraph J—The method of any of Paragraphs A-I, wherein the resid feed is subjected to a pressure drop of at least 400 psig, or more preferably at least 1000 psig, or even more preferably at least 2000 psig when subjected to hydrodynamic cavitation.

Paragraph K—The method of any of Paragraphs A-J, wherein the hydrodynamic cavitation is performed by a hydrodynamic cavitation unit and the resid feed is fed to the hydrodynamic cavitation unit at a feed temperature of at least 450° F.

Paragraph L—The method of Paragraph K, wherein the feed temperature is at least 550° F.

Paragraph M—The method of any of Paragraphs A-L, wherein the hydrodynamic cavitation is performed by a hydrodynamic cavitation unit and wherein a portion of the oil stream is fed back to the hydrodynamic cavitation unit.

Paragraph N—The method of Paragraph M, wherein the portion of the oil stream is mixed with the resid feed.

Paragraph O—The method of any of Paragraphs A-N, wherein the light fraction is condensed.

Paragraph P—The method of any of Paragraphs A-O, wherein the hydrodynamic cavitation is performed by a hydrodynamic cavitation unit and wherein at least a portion of the light fraction is fed back to the hydrodynamic cavitation unit after it is condensed.

Paragraph Q—The method of Paragraph O, wherein the condensed light fraction is treated by hydrotreating, sweetening, alkylation, oligomerization, steam cracking, reforming, or combinations thereof.

Paragraph R—The method of any of Paragraphs A-Q, wherein the light fraction is treated before it is fed back to the hydrodynamic cavitation unit.

Paragraph S—The method of any of Paragraphs A-R, wherein the hydrodynamic cavitation is performed in the absence of a catalyst.

Paragraph T—The method of any of Paragraphs A-S, wherein the hydrodynamic cavitation is performed in the absence of a diluent oil or water.

Paragraph U—The method of any of Paragraphs A-T, wherein the hydrodynamic cavitation is performed in the absence of a hydrogen containing gas or wherein a hydrogen containing gas is present at less than 50 standard cubic feet per barrel.

Paragraph V—The method of any of Paragraphs A-U, further comprising obtaining from the oil stream an oil having a viscosity of less than or equal to about 380 cSt at 50° C.

Paragraph W—The method of any of Paragraphs A-V, further comprising obtaining from the oil stream an oil having a specific gravity of between about 0.96 and about 1.01.

Paragraph X—The method of any of Paragraphs A-W, further comprising obtaining from the oil stream an oil having a maximum sulfur level of 3.5 wt % or less.

Paragraph Y—The method of any Paragraphs A-X, further comprising blending a fuel oil cutter stock having a flash point greater than 60° C. with the resid stream prior to hydrodynamic cavitation.

Paragraph Z—A system adapted to perform the method of any of Paragraphs A-Y.

Paragraph AA—A system for treating a hydrocarbon stream for use in a fuel oil comprising: a resid feed, a hydrodynamic cavitation unit receiving the resid feed and subjecting the resid feed to hydrodynamic cavitation to crack at least a portion of the hydrocarbons present in the resid feed and thereby produce a cavitated resid; and a vapor removal device receiving the cavitated resid and adapted to remove a light fraction from the cavitated resid to produce an oil stream having a flash point greater than 60° C.

Paragraph BB—The system of Paragraph AA, wherein the vapor removal device is a stripper.

Paragraph CC—The system of Paragraph AA, wherein the vapor removal device is a single stage flash vessel.

What is claimed is:

1. A method of treating a hydrocarbon stream for use in a fuel oil comprising:
subjecting a resid feed to hydrodynamic cavitation to crack at least a portion of the hydrocarbons present in the resid feed and thereby produce a cavitated resid; and
removing a light fraction from the cavitated resid to produce an oil stream having a flash point greater than 60° C.

2. The method of claim 1, further comprising preparing a fuel oil comprising the oil stream.

3. The method of claim 1, wherein the resid feed has a T95 of 800° F. or greater.

4. The method of claim 1, wherein the resid feed comprises a 1050+° F. boiling point fraction, and wherein 1 to 35 wt % of the 1050+° F. boiling point fraction is converted to lower molecular weight hydrocarbons when subjected to hydrodynamic cavitation.

5. The method of claim 1, wherein the cavitated resid stream has a viscosity less than 50% of the viscosity of the resid feed as measured at 40° C. as determined by ASTM D445.

6. The method of claim 1, wherein the oil stream has an API gravity greater than the resid feed.

7. The method of claim 1, wherein the oil stream has a solubility number that is at least 10 points greater than the insolubility number of the oil stream.

8. The method of claim 1, wherein the light fraction is scrubbed with an amine solution.

9. The method of claim 8, wherein the light fraction is used as a fuel gas after being scrubbed with an amine solution.

10. The method of claim 1, wherein the resid feed is subjected to a pressure drop of at least 400 psig when subjected to hydrodynamic cavitation.

11. The method of claim 10, wherein the pressure drop is at least 1000 psig.

12. The method of claim 11, wherein the pressure drop is at least 2000 psig.

13. The method of claim 1, wherein the hydrodynamic cavitation is performed by a hydrodynamic cavitation unit and the resid feed is fed to the hydrodynamic cavitation unit at a feed temperature of between 450 and 750° F.

14. The method of claim 13, wherein the feed temperature is at least 550° F.

15. The method of claim 1, wherein the hydrodynamic cavitation is performed by a hydrodynamic cavitation unit and wherein a portion of the oil stream is fed back to the hydrodynamic cavitation unit.

16. The method of claim 15, wherein the portion of the oil stream is mixed with the resid feed.

17. The method of claim 1, wherein a portion of the light fraction is condensed.

18. The method of claim 1, wherein the hydrodynamic cavitation is performed by a hydrodynamic cavitation unit and wherein at least a portion of the light fraction is fed back to the hydrodynamic cavitation unit after it is condensed.

19. The method of claim 17, wherein the condensed light fraction is treated by hydrotreating, sweetening, alkylation, oligomerization, steam cracking, reforming, or combinations thereof.

20. The method of claim 18, wherein the light fraction is treated before it is fed back to the hydrodynamic cavitation unit.

21. The method of claim 1, wherein the hydrodynamic cavitation is performed in the absence of a catalyst.

22. The method of claim 1, wherein the hydrodynamic cavitation is performed in the absence of a diluent oil or water.

23. The method of claim 1, wherein the hydrodynamic cavitation is performed in the absence of a hydrogen containing gas or wherein hydrogen containing gas is present at less than 50 standard cubic feet per barrel.

24. The method of claim 1, further comprising obtaining from the oil stream an oil having a viscosity of less than or equal to about 380 cSt at 50° C.

25. The method of claim 1, further comprising obtaining from the oil stream an oil having a specific gravity of between about 0.96 and about 1.01.

26. The method of claim 1, further comprising obtaining from the oil stream an oil having a maximum sulfur level of 3.5 wt % or less.

27. The method of claim 1, further comprising blending a fuel oil cutter stock having a flash point greater than 60° C. with the resid stream prior to hydrodynamic cavitation.

28. A system for treating a hydrocarbon stream for use in a fuel oil comprising:
a resid feed,
a hydrodynamic cavitation unit receiving the resid feed and subjecting the resid feed to hydrodynamic cavitation to crack at least a portion of the hydrocarbons present in the resid feed and thereby produce a cavitated resid; and
a vapor or gas removal device receiving the cavitated resid and adapted to remove a light fraction from the cavitated resid to produce an oil stream having a flash point greater than 60° C.

29. The system of claim 28, wherein the vapor or gas removal device is a stripper.

30. The system of claim 28, wherein the vapor or gas removal device is a single stage flash vessel.
